(19) United States
(12) Patent Application Publication
(10) Pub. No.: US 2025/0145511 A1
(43) Pub. Date: May 8, 2025

(54) ELECTRIC GLASS FURNACE, METHODS FOR THE MELTING AND MANUFACTURE OF GLASS BY MEANS OF SAID FURNACE

(71) Applicant: SAINT-GOBAIN ISOVER, COURBEVOIE (FR)

(72) Inventors: Jean-François ZIMMERMANN, COURBEVOIE (FR); Joël GERVAIS, COURBEVOIE (FR); Philippe DE DIANOUS, COURBEVOIE (FR)

(21) Appl. No.: 18/729,391

(22) PCT Filed: Jan. 24, 2023
(86) PCT No.: PCT/FR2023/050098

§ 371 Date: Jan. 15, 2025

(30) Foreign Application Priority Data
Jan. 25, 2022 (FR) FR2200637

(51) Int. Cl. C03B 5/16; C03B 5/02; F27D 1/00; F27D 3/14; F27D 11/04; H05B 3/03

(52) U.S. Cl. CPC C03B 5/16; C03B 5/02; F27D 1/0006; F27D 3/14; F27D 11/04; H05B 3/03

(57) ABSTRACT

The invention relates to an electric glass furnace (100) comprising a tank (110) with a cold or semi-cold top and also electrodes (150) for melting raw materials (130) introduced into the tank and thereby obtaining a bath (120) of molten material, the tank having a side wall (112) comprising an opening (113) configured to allow the molten material to flow out of the tank. The furnace additionally has means referred to as “delaying” means (170, 180), which are at least partially immersed in the bath and are positioned in vertical alignment with the opening and in proximity to the side wall of the tank and are configured to increase the dwell time, in the tank, of the raw materials that are introduced in proximity to the delaying means.

### PRIOR ART

The present invention belongs to the general field of glass production. It relates more particularly to an electric glass furnace configured to allow the melting of raw materials. It also relates to a method for melting raw materials implemented by means of this electric glass furnace, as well as a method for manufacturing glass comprising a step of melting raw materials in accordance with said melting method.

Different examples of furnace designs for the manufacture of glass that depend in particular on the product to be manufactured, i.e. on the chemical composition of the glass and on its final shaping (glass wool, rock wool, hollow glass, or even flat glass).

In the present description, “raw materials” is understood to mean all materials, vitrifiable materials, natural ores or synthesized products, materials derived from recycling such as cullet, etc. which can enter the composition that feeds a glass furnace.

Likewise, “glass” is understood to mean glass in the broad sense, i.e. encompassing any material with a vitreous, glass-ceramic or ceramic matrix.

In addition, the term “manufacturing” comprises the indispensable step of melting the raw materials and, if necessary, all the subsequent steps of refining/conditioning the molten glass for its final shaping, in particular in the form of flat glass (glazings), hollow glass (bottles, jars), glass in the form of mineral wool (in particular rock wool or glass wool) used for its thermal or sound insulation properties, or even optionally glass in the form of textile yarns used in reinforcement.

More particularly, it is known to use an electric glass furnace to carry out the melting of raw materials, so as to obtain a bath of vitrifiable materials, still commonly called a “vitrifiable mixture” or “composition”.

The vitrifiable mixture typically originates from raw materials comprising, for example, a mixture of sand, limestone (calcium carbonate), soda ash and dolomite for the manufacture of soda-lime glass (the glass most commonly used for flat glass manufacture) or boron trioxide for the manufacture of borosilicate glass, and to which cullet, made up of broken glass in order to promote melting, is advantageously added.

These raw materials are converted into a liquid mass forming a bath of molten vitrifiable material wherein even the least miscible particles are dissolved, that is to say the ones richest in silicon dioxide or silica (SiO2) and poorest in sodium oxide (Na2O).

Said electric glass furnace conventionally comprises a tank made of refractory material intended to contain the bath of molten material, the space above the tank being closed by an arch. The raw materials are introduced into the tank via its top, by means of a mechanical device able to carry out this introduction over all or some of the surface of the bath of molten material. This surface constitutes a heat shield making it possible to limit the temperature above the bath. This type of furnace is also called “cold top” (respectively “semi-cold top”) in the case where the entire surface of the bath (respectively only some of the surface of the bath) is intended to be covered with raw materials.

The principle of heating an electric glass furnace is based in particular on the fact that the thermal energy necessary for the melting of the raw materials is provided in the mass of the molten glass (i.e. in the bath of molten material). More precisely, the electric melting of the glass is based on its property of becoming electrically conductive from 800-900° C., with conductivity increasing with temperature. The glass is therefore heated by the Joule effect, the bath of molten material constituting the resistor. The electrical current necessary to obtain this Joule effect is for its part provided by electrodes embedded in this bath.

The material thus melted is conventionally discharged from the tank via an opening made in the lower part of the side wall of the tank. This side opening is generally (but not necessarily) extended by a groove allowing the flow of the molten material to other areas. These may be areas wherein refining, homogenization, or thermal conditioning steps are implemented, as well as final glass shaping (as with the manufacture of flat glass, hollow glass, etc.). Alternatively, when the product intended to be manufactured is glass in the form of mineral wool (in particular rock wool or glass wool), the molten material can be directly conveyed, at the groove outlet and after optional thermal conditioning, to a suitable fiberizing station.

In practice, it is noted that the raw materials introduced straight (i.e. in vertical alignment) with the side opening are those which are discharged as quickly as possible. This rapid discharging has its origin not only in the short distance separating the area of introduction of the raw materials from the opening in question, but also in the heat convection movements prevailing within the bath of molten material.

Such a speed of discharge proves to be detrimental to the final quality of the glass intended to be manufactured. Indeed, insofar as the raw materials thus introduced vertically to the side opening have a very short dwell time in the bath of molten material, there is a significant risk that their melting might be incomplete when they leave the tank. However, the presence of un-molten (i.e. not completely melted) residues is known to alter the final quality of the glass (e.g. presence of particles, variation in viscosity, variations in thickness in the finished product, etc.) in the case of the manufacture of flat glass and hollow glass, and also to clog the fiberizing spinners, or even cause them to break, in the case of the manufacture of glass in the form of mineral wool (in particular rock wool or glass wool).

### OVERVIEW OF THE INVENTION

The objective of the present invention is to remedy all or part of the disadvantages of the prior art, in particular those described above, by proposing a solution that makes it possible to very greatly limit the presence of un-molten residues originating from raw materials introduced in proximity to the vertical of the opening formed in the side wall of an electric glass furnace comprising a cold or semi-cold top tank.

To this end, and according to a first aspect, the invention relates to an electric glass furnace comprising a cold or semi-cold top tank and also electrodes for melting raw materials introduced into the tank and thus obtain a bath of molten material, the tank having a side wall comprising an opening configured to allow the molten material to flow out of the tank. The furnace additionally has means referred to as “delaying” means which are at least partially immersed in the bath and are positioned in vertical alignment with the opening and in proximity to the side wall of the tank and are configured to increase the dwell time, in the tank, of the raw materials that are introduced in proximity to the delaying means.

It should be noted that here, “in proximity to the delaying means” means not only in proximity to the zone located at the surface of the bath directly in vertical alignment with the opening made in the side wall, but also to the zone located at the surface of the bath and which substantially precedes said delaying means when moving horizontally away from said side wall.

Thus, said delaying means prove to be particularly advantageous in that they make it possible, due to the increase in said dwell time, to very greatly limit the risk of the presence of unmeltable materials coming from raw materials introduced into the tank in proximity to the vertical of the opening in the side wall.

In particular embodiments, the furnace may further comprise several of the following features, taken alone or in any technically feasible combinations.

In particular embodiments, said delaying means comprise a plate comprising a layer made of refractory material and arranged in contact with or in the vicinity of the side wall of the tank, said plate extending in a substantially horizontal middle plane in which it is kept fixed.

Such a plate, due to its arrangement, therefore makes it possible not only to prevent raw materials directly from falling vertically from the opening, but also advantageously prevents the raw materials that reach the bath in the vicinity of said plate from being dragged too quickly by convection movements in the direction of said opening.

In particular embodiments, the plate is substantially inclined, from the side wall, towards a lower wall of the tank.

Such arrangements are advantageous in that they enable the raw materials that are introduced in vertical alignment with the opening to not accumulate above the plate. The tilt of the plate relative to the horizontal makes it possible in fact that the materials thus introduced slide toward the bath moving away from the side wall.

In particular embodiments, said delaying means comprise a plate comprising a layer made of refractory material and arranged in contact with or in the vicinity of the side wall of the tank, said plate being retractable between two positions comprising a first substantially horizontal position and a second substantially vertical position.

Considering a retractable plate advantageously makes it possible to control the moments at which it is actually desired to increase the dwell time in the tank of the raw materials introduced close to said plate.

In particular embodiments, said plate is heated, the refractory material of said plate being a conductive material, for example molybdenum or platinum.

Heating of the plate makes it possible, quite particularly when the plate is in the vertical position, to invert the convection currents created in the bath and located locally opposite the side wall in vertical alignment with the opening, so as to bring back toward the center of the bath the raw materials introduced into the tank close to said plate. This results in an increase in the dwell time in the tank of the raw materials thus introduced. What is more, the heating of the plate makes it possible to locally increase the temperature of the glass in the bath, which also participates in increasing the quality of the melt.

In particular embodiments, said delaying means comprise a plate comprising a layer made of refractory material and arranged in contact with or in the vicinity of the side wall of the tank, said plate extending in a substantially vertical middle plane in which it is kept fixed and being heated, the refractory material of said plate being a conductive material, for example molybdenum or platinum.

In particular embodiments, the plate is immersed in the bath of molten material at a distance from the surface of said bath, preferentially at a distance less than or equal to 10 centimeters from the surface of said bath.

In particular embodiments, the plate has a dimension greater than or equal to that of the opening in a transverse direction measured along the side wall of the tank.

Generally, the dimensions of the plate do not limit the invention. However, the inventors found that excellent results, in terms of increasing the dwell time in the tank of the raw materials introduced, are obtained when the plate has a dimension greater than or equal to that of the opening in said transverse direction.

In particular embodiments, the plate extends, in said transverse direction, on either side of the opening, for example symmetrically, more particularly over a distance less than or equal to 20% of the dimension of said opening in said transverse direction.

In particular embodiments, the plate extends in said middle plane (i.e. horizontally or vertically according to the considered case) over a distance of between 30 centimeters and 50 centimeters.

In particular embodiments, said delaying means comprise at least one electrode, for example two electrodes, formed in a distinct manner from a plate and arranged substantially vertically or substantially horizontally, said at least one electrode being distinct from the electrodes configured to melt the raw materials introduced into the tank.

Using such at least one electrode makes it possible to invert the convection currents created in the bath and located locally opposite the side wall in vertical alignment with the opening, so as to bring back toward the center of the bath the raw materials introduced into the tank close to said electrodes, which results in an increase in the dwell time in the tank of the raw materials thus introduced. What is more, the heating of the plate makes it possible to locally increase the temperature of the glass in the bath, which also participates in increasing the quality of the melt.

In particular embodiments, the side opening is created by a dam, for example a vertically removable dam.

According to a second aspect, the invention relates to a method for melting raw materials implemented by means of an electric glass furnace according to the invention.

According to a third aspect, the invention relates to a method for manufacturing glass comprising a step of melting raw materials in accordance with a melting method according to the invention.

### BRIEF DESCRIPTION OF THE DRAWINGS

Other features and advantages of the present invention will become apparent from the description given below, with reference to the appended drawings that illustrate an exemplary embodiment thereof devoid of any limiting character. In the figures:

FIG. 1 schematically depicts, in its environment, a particular embodiment of an electric glass furnace according to the invention;

FIG. 2 schematically depicts, in its environment, another particular embodiment of the electric glass furnace according to the invention;

### FIG. 3 schematically depicts, in its environment, yet another particular embodiment of the electric glass furnace according to the invention;

FIG. 4 schematically depicts, in its environment, yet another particular embodiment of the electric glass furnace according to the invention;

FIG. 5 schematically depicts, in its environment, yet another particular embodiment of the electric glass furnace according to the invention;

FIG. 6 is a table for comparing the efficacy of a furnace in accordance with the invention with a traditional furnace as known from the prior art.

### DESCRIPTION OF EMBODIMENTS

FIG. 1 schematically depicts, in its environment, a particular embodiment of an electric glass furnace 100 according to the invention.

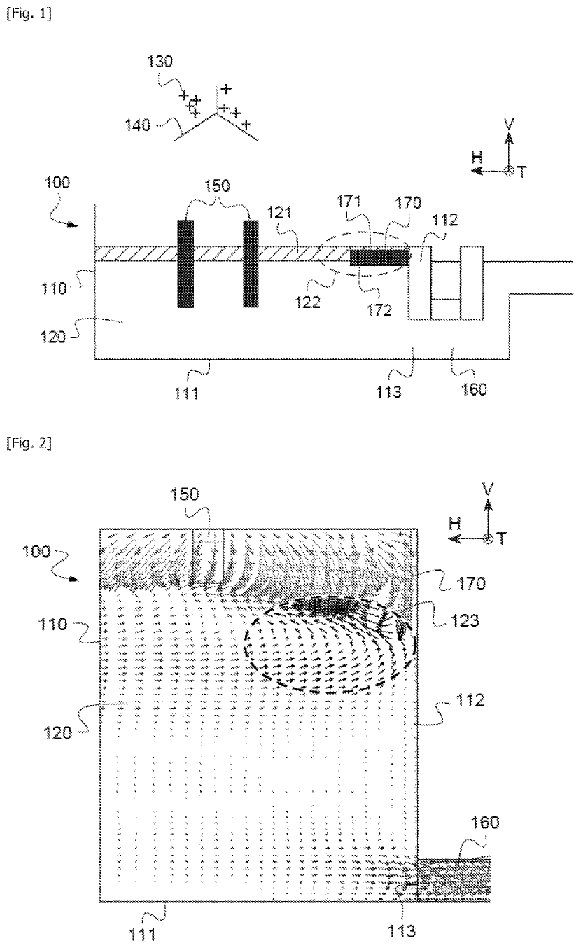

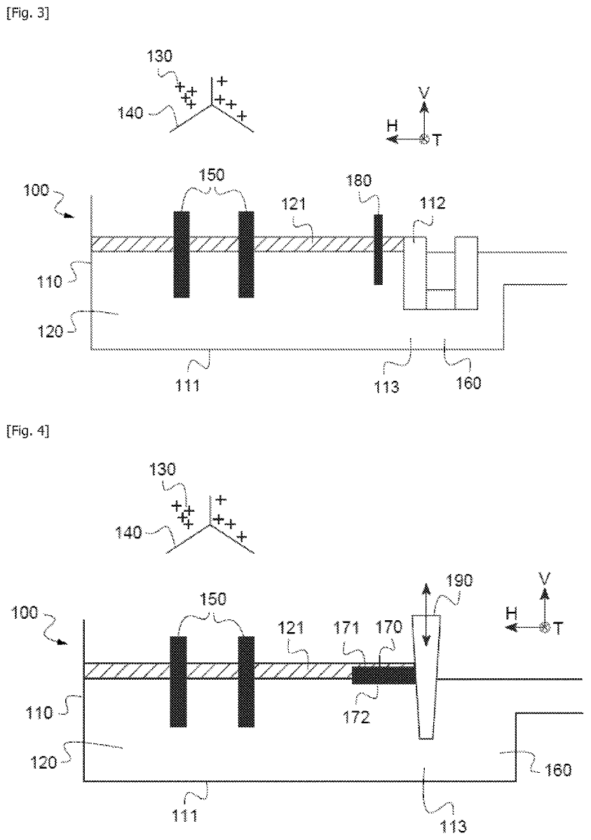

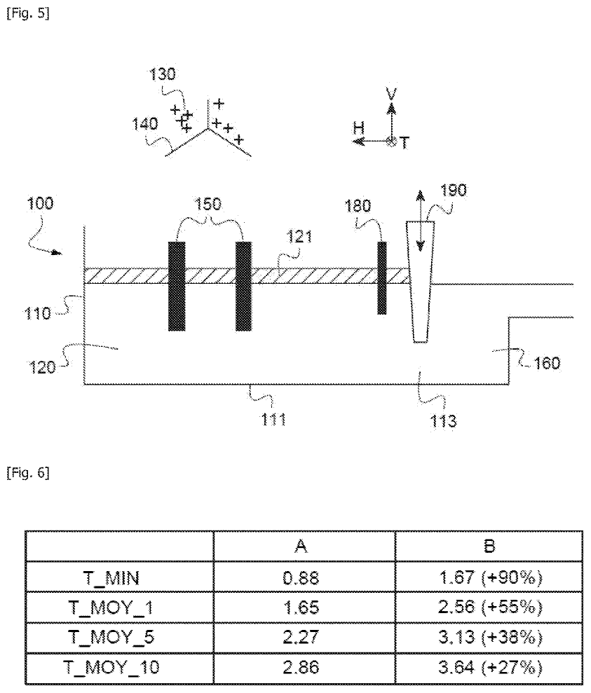

In the remainder of the description, the horizontal, vertical, and transverse directions will be used without limitation in reference to the axis system (H, V, T) shown in FIGS. 1 to 2. Also, the electric glass furnace 100 of FIG. 1 is shown in a vertical section.

By convention, the terms “upper” and “lower” or “top” and “bottom” or “above” and “below” are used in reference to the vertical orientation.

Said electric glass furnace 100 is configured to carry out the melting of raw materials with the aim of forming a bath of vitrifiable molten material. The material thus melted is intended for the manufacture of glass, the electric glass furnace 100 being integrated, for this purpose, into a glass manufacturing installation comprising, in zones other than those where the electric glass furnace 100 is implemented, various devices (not shown in the figures) capable of implementing steps of refining and/or homogenization and/or thermal conditioning and/or final shaping of the glass. Such steps are well known to a person skilled in the art, so they are not described further here.

For the remainder of the description, it is considered in a non-limiting manner that the glass intended to be manufactured from the molten material in the electric glass furnace 101 is a product of the insulating glass type. However, it should be noted that considering the manufacture of such an insulating glass constitutes only one alternative embodiment of the invention. Thus, and in general, no limitation is attached to the type of glass intended to be manufactured by means of the molten material in the electric glass furnace 100 according to the invention (example: flat glass, glass in the form of mineral wool, glass in the form of textile yarns, etc.).

It should be noted that the composition of the raw materials making it possible to manufacture a product of the insulating glass type is also well known to a person skilled in the art and therefore not described in detail here.

Of course, such an observation also applies to all other types of glass that can be manufactured according to the invention.

In the embodiment shown in FIG. 1, the electric glass furnace 100 is of parallelepipedal shape, and conventionally comprises a tank 110 wherein the raw materials are melted so as to obtain the bath 120 of molten material.

The tank 110 has a lower wall 111 forming the bottom of the electric glass furnace 100 and extending horizontally, as well as a side wall 112 rising vertically from said lower wall 111, the transverse axis T extending along said side wall 112. The tank 110 of the electric glass furnace 100 is here a cold-top tank, and is therefore topped by a top (not shown in the figures) made of a material known per se, for example a clay material such as sillimanite.

The tank 110 (i.e. the walls of the tank 110) is made of refractory material, for example made of alumina-zirconia-silica (AZS) or chromium. The side wall 112 generally comprises an external metal casing (also called a “reinforcement”) in contact with the ambient air. This metal casing may comprise two partitions between which a cooling fluid circulates, for example water (a so-called “water jacket” wall).

Considering an electric glass furnace of parallelepipedal shape and comprising a cold-top tank of course does not constitute a limitation of the invention. Thus, nothing precludes considering another form, such as, for example, a cylindrical shape with a circular base, as well as a semi-cold top tank.

Similarly, nothing precludes considering a lower wall 111 inclined relative to the horizontal, for example in the form of a cone pointing downward or else an inclined plane, so as to promote the driving toward the bottom of the tank 110 of molten vitrifiable material at the start of melting.

The raw materials 130 useful for the manufacture of the glass are introduced into the tank 110 via its top, by means of a mechanical device 140 able to carry out this introduction onto the surface of the bath 120 of molten material, more particularly over the entire surface of the bath 120, given that the tank 110 is here considered to be a cold top. By way of non-limiting example, and as shown by FIG. 1, said mechanical device 140 corresponds to a batch charger with a rotary mat (also called a “boom”) that deposits the composition at any point on the surface of the bath.

The raw materials 130 thus introduced and not yet melted form a crust 121 on the surface of the bath 120 before melting and feeding the actual molten material of the bath 120.

The melting of the raw materials 130 introduced into the tank 110 is carried out by means of electrodes 150. Furthermore, the power dissipated around the electrodes 150 makes it possible to generate areas of strong convections in the bath 120, thus creating sufficiently intense currents to provide the necessary calories at the boundary between the already-melted material and the crust 121.

In the present embodiment, the electrodes 150 are arranged on the surface so as to dip into the bath 120 of molten material, through the crust 121. Furthermore, the immersed electrodes 150 extend vertically, and are, in the example of FIG. 1, two in number, and made of refractory material (resistant to temperatures greater than 1000° C.), for example made of molybdenum. It is also noted that said electrodes 150 are, conventionally, distributed in the vicinity of the center of the bath 120.

Of course, other alternative embodiments of the electrodes can be envisaged, such as for example submerged electrodes extending obliquely, that is to say inclined relative to the vertical orientation. Furthermore, the number of dipping electrodes does not constitute a limiting factor of the invention provided that it is greater than two.

Alternatively or in addition to the electrodes 150 arranged on the surface of the bath 120 and immersed in the latter, it may also be envisaged to use rising electrodes (as opposed to the dip electrodes) arranged through the lower wall 111 so as to be immersed in the bath 120. Again, such rising electrodes can extend vertically or alternatively obliquely.

Finally, optionally in addition to the previous variants, electrodes introduced through the vertical wall 110 can also be envisaged.

The side wall 112 of the tank 110 comprises an opening 113, also called a “side opening 113” in the rest of the description. This side opening 113 is configured to allow the molten material of the bath 120 to flow out from the tank 110. It should be noted that this side opening 113 does not cover the entire dimension of the side wall 112 in the transverse direction T.

More particularly, and as shown in FIG. 1, the side opening 113 forms an outlet for the molten material which can therefore flow, via a discharge channel 160 forming a groove, to other areas wherein steps of refining and/or homogenization and/or thermal conditioning and/or final shaping of the glass are typically implemented.

In the present embodiment, the side opening 113 has a rectangular shape, of larger dimension (i.e. length) in the transverse direction T. However, it is understood that this is only a particular embodiment variant, and that, ultimately, no limitation is attached to the shape of the side opening 113.

Furthermore, and as shown in FIG. 1, it is considered here that the side opening 113 is arranged in the lower part of the side wall 112, at the lower wall 111. However, it is still possible to envisage other variants wherein the side opening 113 is arranged at a level lower than that of the lower wall 111, or else in the upper part of the side wall 112 (i.e. closer to the surface of the bath 120 than to the lower wall 111).

According to the invention, the electric glass furnace 100 also comprises so-called “delaying” means which are at least partially immersed in the bath 120, positioned in vertical alignment with the side opening 113 and in the vicinity of the side wall 112 of the tank 110, as well as configured to increase the dwell time in the tank 110 of the raw materials 130 introduced close to said delaying means.

It should be noted that here, “in proximity to the delaying means” means not only in proximity to the zone located at the surface of the bath 120 directly in vertical alignment with the side opening 113 (i.e., along the vertical side wall 112), but also to the zone located at the surface of the bath 120 and which substantially precedes said delaying means when moving horizontally (therefore to the left in the horizontal direction H in FIG. 1) away from said side wall 112, but also which extends substantially on either side of said delaying means in the transverse direction T.

Purely by way of illustration, these two zones are contained in the space 122 delimited by a dotted boundary in FIG. 1, it being understood that this space 122 extends both in the horizontal direction H and in the transverse direction T.

Such delaying means prove to be particularly advantageous in that they make it possible, due to the increase in said dwell time, to very greatly limit the risk of the presence of unmeltable materials coming from raw materials 130 introduced into the tank 110 in proximity to the vertical of the side opening 113.

It should also be noted that increasing the dwell time in the tank 110 of raw materials 130 introduced close to said delaying means ultimately makes it possible to increase the minimum dwell time of all of the raw materials introduced into said tank 110 (and therefore ultimately to give them more time to melt).

In the embodiment of FIG. 1, said delaying means comprise a plate 170 comprising a layer made of refractory material (i.e. resistant to temperatures greater than 1000° C.).

As a non-limiting example, said refractory material is based on magnesia and/or chromium, or else is of the alumina-zirconia-silica type (electrofused or not). Yet another category that can be envisaged is that of materials based on metals at high temperatures (example: so-called refractory steels such as molybdenum or platinum) or cooled.

In the present embodiment, said plate 170 is arranged in contact with the side wall 112 of the tank 110, here along its edge. It has a parallelepipedal shape, and comprises an upper face 171 and a lower face 172 opposite said upper face 171.

It should be noted that the shape of the plate 170 is here chosen to be parallelepipedal insofar as the tank 110 is itself of parallelepipedal shape. It is understood, however, that for another tank shape 110, the shape of the plate 170 is advantageously adapted so that the latter is in contact with the side wall 112.

Moreover, considering the plate 170 in contact with the side wall 112 constitutes only one alternative implementation of the invention. Indeed, nothing precludes considering that the plate 170 be arranged in the vicinity of said side wall 112. The term “in the vicinity” refers here to a distance of the order of 1 to 2 centimeters.

The plate 170 is further partially immersed in the bath 120 of molten material and extends in a horizontal plane, called the “middle plane”. More particularly, the plate 170 extends perpendicularly to the side wall 112 of the tank 110 and the upper face 171 (respectively the lower face 172) of the plate 170 is comprised in the crust 121 (respectively is comprised in the bath 120). The plate 170 is also held fixed in said middle plane.

In the example of FIG. 1, the distance separating the lower face 172 of the plate 170 from the surface of the bath 120 is of the order of one centimeter, for example equal to 5 cm.

Furthermore, and by way of non-limiting example, the thickness of the plate 170 is substantially equal to 150 mm. However, there is nothing to rule out other values for the thickness of the plate. Furthermore, and in a more general manner, nothing excludes considering a larger or smaller thickness than that of the crust 121 as soon as the plate 170 is at least partially immersed.

Such a plate 170, due to its arrangement, therefore makes it possible not only to prevent raw materials directly from falling vertically from the side opening 113, but also advantageously prevents the raw materials that reach the bath 120 in the vicinity of said plate 170 (see space 122 shown in FIG. 1) from being dragged too quickly by convection movements in the direction of said side opening 113.

Generally, the horizontal and transverse dimensions of the plate 170 do not limit the invention. However, the inventors found that excellent results, in terms of increasing the dwell time in the tank 110 of raw materials introduced in proximity to said plate 170, are obtained when the plate 170 has:
a dimension greater than or equal to that of the side opening 113 in the transverse direction T, and/or
a horizontal dimension (along the direction H) greater than the vertical dimension (in the direction V) of the side opening 113.

As a non-limiting example, the plate 170 may have, in the transverse direction T or in the horizontal direction H, dimensions of 800 mm and 1200 mm.

Preferably, the plate 170 extends, in said transverse direction T, on either side of the side opening 113, for example symmetrically, more particularly over a distance less than or equal to 20% of the dimension of said side opening 113 in said transverse direction T.

Of course, it is also possible to envisage that the plate 170 extends, in said transverse direction T, only on a single side of the side opening 113.

Furthermore, in the embodiment described here, the plate 170 extends horizontally (i.e. in the direction H) in said middle plane over a distance comprised between 30 cm and 50 cm, for example equal to 40 cm.

A person skilled in the art understands in the foregoing arrangements that the transverse and horizontal dimensions of the plate 170 can advantageously be adapted as a function of those of the side opening 113, the values provided previously therefore constituting in no way limitations on the invention.

Again, other embodiments, listed below, can be envisaged for the plate 170 as described until now with reference to the embodiment shown in FIG. 1. These other embodiments can all be combined with one another according to all technically operable combinations.

Thus, according to one embodiment (not shown by the figures), the horizontal plate 170 is immersed in the bath 120 of molten material at a distance from the surface of said bath, preferentially at a distance less than or equal to 10 centimeters from the surface of said bath. In other words, in this mode, the plate 170 is entirely immersed in the bath 120.

According to one embodiment (not shown by the figures), the horizontal plate 170 comprises, in addition to the layer made of refractory material, a layer made of metallic material to which said layer made of refractory material is attached. According to an even more particular embodiment, an insulating layer can be arranged between said refractory and metallic layers.

According to one embodiment, the horizontal plate 170 is substantially inclined, from the side wall 112, towards the lower wall 111. For example, said inclination is less than 30°, or even less than 15° according to a more particular example. Furthermore, in this embodiment, the bottom of the plate 170, that is to say, its bottom face 172, remains immersed in the bath 120, which makes it possible to prevent the raw materials 130 introduced from circulating from the center of the furnace 100 to the side wall 112, and passes under the plate 170.

Such arrangements are advantageous in that they enable the raw materials that are introduced in vertical alignment with the side opening 113 to not accumulate above the plate 170. The tilt of the plate 170 relative to the horizontal makes it possible in fact that the materials thus introduced slide toward the bath 120 moving away from the side wall 112.

According to yet another embodiment (not shown in the figures), it is also possible to consider that the plate 170 is retractable between two positions comprising:
a first horizontal (or substantially horizontal) position that corresponds to the position described until now for the arrangement of the plate 170,
a second vertical (or substantially vertical, if necessary) position that corresponds to a position wherein the plate 170 is adjoining (or substantially adjoining) the side wall 112.

Considering a retractable plate 170 in such arrangements advantageously makes it possible to control the moments at which it is actually desired to increase the dwell time in the tank 110 of the raw materials 130 introduced close to said plate 170.

Finally, it is also possible to envisage other embodiments wherein said plate 170 is heating.

The heating of the plate 170 is for example carried out by choosing, for the refractory layer of the plate 170, a conductive material, such as, for example, molybdenum or platinum, as well as by connecting the latter to one of the electrodes 150, such an embodiment is advantageously implemented when the plate 170 extends (substantially) vertically, but nothing excludes, of course, a heating when the plate 170 extends (substantially) horizontally. Furthermore, the heating plate 170 can be kept fixed in its nominal position (i.e. vertically or horizontally), or else, according to certain embodiments, be retractable between two respectively vertical and horizontal positions.

It should be noted that when the plate 170 is heating and extends (substantially) vertically, it can be immersed in the bath 120 by having an external part extending outside said bath 120. This external part is for example used to fix the plate 170 to the side wall 112 and made of a material other than the refractory material used for the complementary part located under the surface of the bath 120.

Considering a heating of the plate 170 when it extends (substantially) vertically makes it possible to invert the convection currents created in the bath 120 and located locally opposite the side wall 112 in vertical alignment with the side opening 113. Such inversion of convection currents is illustrated by way of non-limiting example in FIG. 2 wherein the electric glass furnace 100 is represented in a vertical cross-section. In FIG. 2, the convection currents are represented by means of the speed field (arrows contained in the tank 110) of the molten material of the bath 120, and it can clearly be observed therein said inversion of the convection currents (zone 123 surrounded by dotted lines in FIG. 2). The reversal in question therefore advantageously makes it possible to return to the center of the bath 120 the raw materials introduced into the tank 110 close to the plate 170, thus keeping them from being dragged too rapidly through the discharge channel 160.

The invention has been described until now considering only embodiments wherein the delaying means comprise said single plate 170. However, it is possible to envisage still other embodiments.

Thus, FIG. 3 schematically represents, in its environment, another particular embodiment of the electric glass furnace 100 according to the invention wherein the delaying means comprise an electrode 180 arranged substantially vertically, more particularly immersed vertically (“dip”) in the bath 120. Said dip electrode 180 is formed in a distinct manner from a plate (and is therefore a fortiori distinct from the plate 170) as well as partially immersed in the bath 120, but nothing precludes envisaging that it is completely immersed.

To operate, this dip electrode 180 is in the present embodiment, connected to another electrode which corresponds to one of the electrodes 150 arranged in the middle of the bath and used to carry out the melting of the raw materials 130.

Furthermore, although it is considered here that the dip electrode 180 equipping the glass furnace 110 in addition to said electrodes 150 is arranged (substantially) vertically, it is quite possible to consider that it is (substantially) horizontal, from the side wall 112.

As shown in FIG. 3, the electrode 180 differs from the electrodes 150 in that it is positioned in vertical alignment with the side opening 113 and in the vicinity of the side wall 112 of the tank 110. In other words, the electrode 180 forming, in the present embodiment, said delaying means is placed much closer to the side wall 112 than to the electrodes 150 conventionally used to melt the raw materials 130.

Using such an electrode 180 produces a technical effect similar to that described previously for the case where a heating vertical plate is used. Thus, the electrode 180 makes it possible to invert the convection currents created in the bath 120 and located locally opposite the side wall 112 in vertical alignment with the side opening 113, so as to bring back toward the center of the bath 120 the raw materials introduced into the tank 110 in the proximity of said electrode 180. This results in an increase in the dwell time in the tank 110 of the raw materials thus introduced.

Although the mode of FIG. 3 has been described by considering a single electrode 180, it should be noted that this number of electrodes is not limiting on the invention. Thus, nothing precludes, for example, considering that said dip electrode 180 is connected to another electrode of the same type, wherein case said electric glass furnace 100 comprises, in addition to the electrodes 150, two dip electrodes of the same type as that shown in FIG. 1.

The length of the electrode 180 does not represent a limiting factor of the invention. Thus, according to a particular embodiment, the electrode 180 is configured to dip into the bath 120 to a given depth of the tank 110, for example until it has an end opposite the side opening 113.

It should be noted that it has hitherto been considered, with reference to the embodiment of FIG. 3, that the delaying means comprise only said electrode 180, the plate 170 for its part not being present. These arrangements elicit two observations:
1) the plate 170, when it is heating as described above, can be seen as a separate electrode of the electrodes 150 arranged in the middle of the bath and used to carry out the melting of the raw materials 130. In other words, in this mode, the heating plate 170 forms as such an electrode in the same way as the electrode 180 described with reference to FIG. 3;
2) nothing precludes considering further embodiments wherein the plate 170, made or not made of a non-conductive refractory material, is combined with an electrode 180 to form said delaying means. For example, said electrode 180 can be arranged substantially horizontally by passing through said plate 170.

Finally, independently of the embodiment envisaged for said delaying means, the invention has also been described until now considering that the side opening 113 is a cavity made in the material of the side wall 112. However, other alternatives can be envisaged, such as for example an alternative according to which the side opening 113 is created by (result of) a dam 190, for example a vertically removable dam. Conventionally, the width of the dam 190 is adapted to the width of the side opening 113, it being understood that the dam 190 does not extend beyond said side opening 113. In addition, the dam 190 is placed in line with said opening 113.

FIG. 4 and FIG. 5 schematically show embodiments wherein such a dam 190 is implemented, in cases where the delaying means respectively comprise a plate 170 (analogous to FIG. 1) and an electrode 180 (analogous to FIG. 3).

Said dam 190 is for example made of refractory material and/or comprise an enclosure allowing the circulation of a cooling liquid therein (“water jacket”).

It is noted that the dam 190 can be seen as being part of the side wall 112 of the tank 110.

The production of such a dam 190 is not described in more detail here, the document WO 2013/098504 being advantageously consulted for this purpose.

The invention also relates to a method for melting raw materials 130 implemented by means of the electric glass furnace 100 according to the invention. Said melting method (not shown in the figures) comprises a step of introducing raw materials 130 into the tank 110 as well as a step of melting the raw materials 130 thus introduced. Said melting method may further comprise, in a more particular embodiment, a step of discharging, through the side opening 113, the molten material obtained from the melting of the raw materials 130.

Finally, the invention also covers a method for manufacturing glass (not shown in the figures) comprising a step of melting raw materials 130 in accordance with the melting method according to the invention. Said manufacturing method also comprises a step of final shaping of the glass that can be preceded, according to more particular examples of implementation, by steps of refining and/or homogenization and/or thermal conditioning from the molten material that flows out from the tank 110 through the side opening 113 and via the discharge channel 160.

The results obtained for a particular example of embodiment of the electric glass furnace 100 will now be described, in terms of increasing the dwell time in the tank 110 of raw materials 130 introduced in proximity to the delaying means.

More particularly, for this particular embodiment, an electric glass furnace 100 of parallelepiped shape with a rectangular side opening 113 is considered, said oven 100 being intended for the production of insulating glass. The delaying means are here a plate 170, with a thickness equal to 150 mm, with a width (measured in the transverse direction T) equal to the width of the side opening 113 increased by 20% and a length (counted in the horizontal direction H) equal to 70% of the width of the side opening 113. In addition, the plate 170 extends symmetrically, along the transverse direction T, on either side of the side opening 113. Finally, said plate 170 comprises a layer made of an alumina-zirconia-silica type electrofused material.

The results obtained for this exemplary embodiment are listed in the table shown by FIG. 6. These are comparative results expressed in hours, and making it possible to assess, for cases where the plate 170 is used (reference “B” in the table) or not (reference “A” in the table):
the difference in minimum dwell time T_MIN in the tank 110,
the difference in average dwell time T_MOY_1 of the 1% of glass that dwelt the shortest time in the tank 110,
the difference in average dwell time T_MOY_5 of the 5% of glass that dwelt the shortest time in the tank 110,
the difference in average dwell time T_MOY_10 of the 10% of glass that dwelt the shortest time in the tank 110.

It emerges from these results that the use of the plate 170 is particularly advantageous with regard to the underlying technical problem, since the dwell time increases by 90%, 55%, 38% and 27% for respectively T_MIN, T_MOY_1, T_MOY_5 and T_MOY_10 when the electric glass furnace 100 is equipped with said plate 170.

1. An electric glass furnace comprising a tank with a cold or semi-cold top and electrodes for melting raw materials introduced into the tank and thus obtaining a bath of molten material, the tank having a side wall comprising an opening configured to allow the molten material to flow out of the tank, the furnace it further comprising a “delaying” means which are at least partially immersed in the bath and are positioned in vertical alignment with the opening and in proximity to the side wall of the tank, and are configured to increase dwell time, in the tank, of the raw materials introduced into a zone located at a surface of the bath directly in vertical alignment with the opening in the side wall, as well as in a zone located at the surface of the bath and which substantially precedes said delaying means when moving horizontally away from said side wall.

2. The furnace according to claim 1, wherein said delaying means comprise a plate comprising a layer made of refractory material and arranged in contact with or in the vicinity of the side wall of the tank, said plate extending in a substantially horizontal middle plane wherein the plate is kept fixed.

3. The furnace according to claim 2, wherein the plate is substantially inclined, from the side wall, towards a bottom wall of the tank.

4. The furnace according to claim 1, wherein said delaying means comprise a plate comprising a layer made of refractory material and arranged in contact with or in the vicinity of the side wall of the tank, said plate being retractable between two positions comprising a first substantially horizontal position and a second substantially vertical position.

5. The furnace according to claim 2, wherein said plate is a heating plate.

6. The furnace according to claim 1, wherein said delaying means comprise a plate comprising a layer made of refractory material and arranged in contact with or in the vicinity of the side wall of the tank, said plate extending in a substantially vertical middle plane wherein the plate is kept fixed and being heated, the refractory material of said plate being a conductive material.

7. The furnace according to claim 2, wherein the plate is immersed in the bath of molten material at a distance from the surface of said bath.

8. The furnace according to claim 2, wherein the plate has a dimension greater than or equal to that of the opening in a transverse direction measured along the side wall of the tank.

9. The furnace according to claim 8, wherein the plate extends, in said transverse direction, on either side of the opening.

10. The furnace according to claim 2, wherein the plate extends in said middle plane over a distance of between 30 centimeters and 50 centimeters.

11. The furnace according to claim 1, wherein said delaying means comprise at least one electrode formed in a distinct manner from a plate and arranged substantially vertically or substantially horizontally, said at least one electrode being distinct from the electrodes configured to melt the raw materials introduced into the tank.

12. The furnace according to claim 1, wherein the opening is created by a dam.

13. A method for melting raw materials implemented by an electric glass furnace according to claim 1.

14. A method for manufacturing glass comprising melting raw materials in accordance with a melting method according to claim 13.

15. A glass obtained by a method for manufacturing glass according to claim 14.

16. The furnace according to claim 5, wherein the refractory material of said plate is a conductive material.

17. The furnace according to claim 16, wherein the conductive material is chromium or platinum.

18. The furnace according to claim 6, wherein the conductive material is molybdenum or platinum.

19. The furnace according to claim 7, wherein the distance is less than or equal to 10 centimeters from the surface of said bath.

20. The furnace according to claim 9, wherein the plate extends, in said transverse direction, symmetrically, or over a distance less than or equal to 20% of a dimension of said opening in said transverse direction, or both.
